(19) United States
(12) Patent Application Publication
(10) Pub. No.: US 2025/0214668 A1
(43) Pub. Date: Jul. 3, 2025

(54) Locking and Unlocking Apparatus and Method

(71) Applicant: myStromer AG, Oberwangen (CH)

(72) Inventor: Dominic Sahli, Bühl (CH)

(21) Appl. No.: 18/851,668

(22) PCT Filed: Jun. 23, 2023
(86) PCT No.: PCT/IB2023/056494

§ 371 Date: Sep. 26, 2024

(30) Foreign Application Priority Data
Jul. 8, 2022 (CH) CH000816/2022

(51) Int. Cl. B62H 5/00; B62J 43/13; B62J 43/28; B62M 6/90

(52) U.S. Cl. CPC B62H 5/001; B62J 43/13; B62J 43/28; B62M 6/90

(57) ABSTRACT

The present invention relates to a locking and unlocking apparatus for an electrically driven vehicle, in particular an electric bicycle. The apparatus comprises a housing for receiving components, a built-in element for mechanical unlocking of the battery, wherein the built-in element comprises an actuating element for releasing the unlocking of the battery, and an electronic unlocking element. The apparatus is advantageously connected to a release device for releasing the mechanical unlocking of the battery by means of an electronic unlocking element.

### FIELD OF TECHNOLOGY

The present invention relates to a locking and unlocking apparatus for an electrically driven vehicle, in particular for an electric bicycle, also known as an e-bike.

The invention also relates to methods for locking and unlocking, all according to the general terms of the independent claims.

### TECHNOLOGICAL BACKGROUND

Locking and unlocking devices are known from the state of the art. On e-bikes, they are used for inserting and locking as well as removing a battery, in particular a rechargeable battery on the bike.

A battery is an energy storage element such as a rechargeable battery. A battery can usually be charged or recharged both when installed and externally from the bike.

Conventional solutions for charging the battery on or in the bicycle frame require a separate charging socket. The separate charging socket and locking/unlocking device must be installed separately in the bicycle frame, i.e. assembly and disassembly are extremely cumbersome.

The charging socket is connected to an external power source or socket using a charging cable. Depending on the capacity and charging current, charging can take several hours.

As bicycles equipped with batteries of this type have a very high value, the theft protection of such a bicycle and the battery is not of insignificant interest. A frequent disadvantage of locking and unlocking devices from the prior art is that it is relatively easy to access the electronics of the locking and unlocking device. A thief can use simple tools, such as a screwdriver, to manipulate the electronics and, in the worst case, unlock the battery from the outside.

There is a general need for improvements in this area. In particular, there is a need for new solutions that address the aforementioned disadvantages of the state of the art.

### REPRESENTATION OF THE INVENTION

It is therefore a task of the present invention to provide an improved locking and unlocking apparatus which not only enables safe locking and unlocking of a battery, but also allows the battery to be charged.

These and other tasks are solved by a apparatus according to the independent claim. Further advantageous embodiments are given in the dependent claims.

The solution according to the invention can be further improved by various embodiments, each of which is advantageous in its own and, unless otherwise stated, can be combined with one another as desired. These embodiments and the advantages associated with them are discussed below.

One aspect of the present invention relates to a locking and unlocking apparatus for an electrically driven vehicle, in particular an electric bicycle. The device comprises a housing for receiving components, a built-in element for mechanical battery unlocking, wherein the built-in element comprises an actuating element for releasing the battery unlocking, and an electronic unlocking element. The apparatus can be connected to a release device for releasing the mechanical battery unlocking by means of an electronic release element.

The built-in element with actuating element can also be referred to as an opening latch, which can be used to unlock the battery by bridging or overpressing at an angle of more than 90°.

Due to the design of the apparatus, a battery can advantageously be locked and unlocked as well as charged using the same apparatus. This means that components and material can be saved, as it is not necessary to provide different or separate devices for locking, unlocking and charging. In addition, the theft protection of the battery is increased. Access to the underlying electronics within the bicycle frame is made more difficult or impossible. A thief cannot manipulate the electronics using simple tools such as a screwdriver.

Preferably, the housing has access or a recess to a charging socket or a charging connection. This access makes it easy to connect a charging cable or plug. Access to the charging socket is gained by angling the opening latch by approx. 90°.

If the built-in element is movable for opening or closing, it can be moved and used for several functions. A double or multiple function is advantageous. When closed, the built-in element also has a protective function against dirt and moisture. Depending on the design, it can latch onto the housing and prevent splash water from entering. In an alternative embodiment, the built-in element has additional sealing means so that the apparatus according to the invention is watertight or almost watertight in a closed state. Sealing rings or good fits are particularly suitable for this purpose.

The built-in element can be attached to the housing by means of a spring arrangement. The spring arrangement comprises a first spring, a shaft and a locking ring. The spring arrangement not only allows the built-in element to move, but also to snap back into its original position. This is realized by a spring preload. The spring preload can be overcome with the actuating element by bridging with an opening angle of more than 90°. When the actuating element is folded back to an opening angle of 90° or less, the spring arrangement resumes its preload.

The mechanical battery unlocking has a second spring for ejecting a battery. The second spring also provides a spring preload so that the battery can be ejected easily. After the unlocking process, the battery moves towards the user up to a defined end stop. This ensures that the battery can be removed easily. In alternative embodiments, additional signaling elements are provided which can signal unlocking or locking or ejection or reinsertion of the battery. This can take the form of acoustic or haptic signals, for example by means of push pins on the battery or on the bicycle frame.

If the battery is mechanically unlocked by means of an actuating element and the actuating element has an opening angle of more than 90°, the battery can be safely ejected via a deflection lever.

The housing can be installed in a recess of a vehicle frame in a form-fitting manner and protected by means of a securing bracket. It is advantageous that the housing has grooves or recesses into which the securing bracket enters or engages and prevents the housing from being removed. This provides increased protection against theft, as access to the battery is made more difficult and prevented. In a further advantageous embodiment, the securing bracket can only be inserted or removed after the battery has been removed. This prevents the locking and unlocking device from being removed from the recess in the bicycle frame in the event of theft and a thief from gaining access to the electronics or other elements. The securing bracket therefore provides additional security when the battery compartment is closed. When the battery compartment is open, the securing bracket can be removed in order to easily replace the housing with the components. This ease of replacement is particularly advantageous in the event of a defect.

If the mechanical battery unlocking is carried out by the release device using the electronic unlocking element and the actuating element is moved to an opening angle of 90° or more, the battery can be safely ejected via a deflection lever. Two conditions must therefore be met in order to eject the battery, which in turn leads to increased protection.

Mechanical battery locking takes place advantageously when the actuating element is at an opening angle of 90° or less. The battery can then simply be pushed in. The ejection mechanism is not active.

The electronic unlocking element can include an electric solenoid. This can be easily activated and is only the first step towards battery ejection. Only after the electronic unlocking element, i.e. the electric solenoid coil, is activated and the release is enabled, does a second step take place by means of the actuating element.

If the release device is configured for mechanical battery unlocking by means of a code to be entered, only the user who knows the code can unlock the battery. This can be adapted to the security requirements of the respective user. The release device can be designed as a management device. In a preferred embodiment, the release device comprises a user device with a display, for example an information processing unit with a graphical user interface (GUI). In another preferred embodiment, the release device comprises a smartphone or similar external device. The latter embodiment allows the battery to be unlocked from any location, which may be at a distance from the electric bicycle. In another possible embodiment, the release device is connected to a contact switch. In this way, the user could be informed via smartphone that the battery release has been activated on their bicycle. This provides additional safety. In yet another possible embodiment, the release device is simply a button that is connected to the electronic unlocking element.

Mechanical battery locking is achieved by closing the actuating element after the battery has been inserted. The actuating element is then in its home or initial position. Electronic locking takes place automatically after the battery has been reinserted. This makes it easier to quickly return the electric bicycle to a rideable state after charging the battery.

A further aspect of the present invention relates to a vehicle frame for an electrically driven vehicle, in particular an electric bicycle, for receiving and coupling with the disclosed apparatus.

Still another aspect of the present invention relates to a method for unlocking an electrically driven vehicle, in particular an electric bicycle, by means of the specified device. The method comprises the steps of releasing the mechanical battery unlocking by the release device by means of an electronic unlocking element and opening the actuating element via an opening angle of more than 90°. The unlocking process is therefore a two-stage process: first an electronic release and then a mechanical release. Alternatively, the first step can also be carried out mechanically.

Still another aspect of the present invention relates to a method of locking for an electrically driven vehicle, in particular an electric bicycle, using the disclosed apparatus. The method comprises the step of closing the actuating element to a closing angle of 90° or less.

It is self-evident to a person skilled in the art that all the preferred and particular embodiments described may be realized in any combination in an embodiment according to the invention, provided that they are not mutually exclusive.

In the following, the present invention will now be explained in more detail with reference to specific embodiments and figures, without, however, being limited to these. Further advantageous embodiments will become apparent to a person skilled in the art from studying these specific embodiments. For the sake of simplicity, the same parts are given the same reference signs in the figures. Further aspects of the present invention are also apparent from the following description.

### BRIEF DESCRIPTION OF THE DRAWINGS

The following figures are used to describe embodiments of the invention. The figures are not to scale. They show:

FIG. 1a magnification of a view of the apparatus according to the invention;

FIG. 1b an electric bicycle with an apparatus according to the invention;

FIG. 2 a-d a housing of the apparatus according to the invention in various three-dimensional representations;

FIG. 3 a housing with other components in a disassembled state;

FIG. 4 a-b a housing with securing bracket in three-dimensional representation;

FIG. 5 a section of the electric bicycle with connected charging connection;

FIG. 6 an enlargement of the apparatus according to the invention with electronic unlocking element;

FIG. 7 an enlargement of the apparatus according to the invention with force directional effects in the unlocked state and with the charging socket hidden; and

FIG. 8 an enlargement of the apparatus according to the invention in the closed or locked state and with the charging socket hidden.

Identical or similar reference signs are used in the following figures and the associated description for parts that have the same or the same effect.

### EXECUTION OF THE INVENTION

The examples given below serve to better illustrate the invention but are not intended to limit the invention to the features disclosed herein.

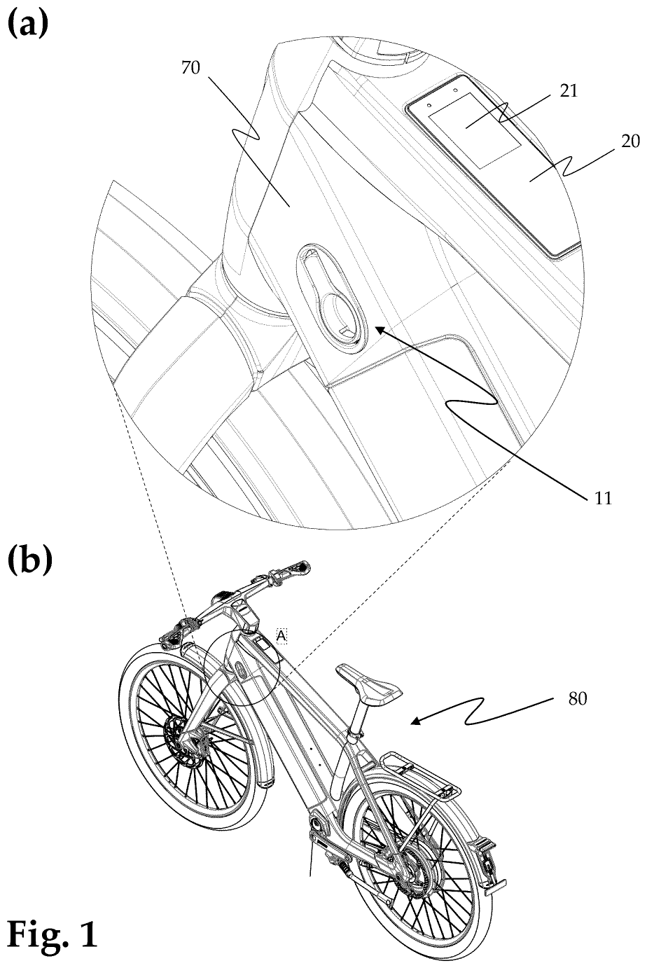

FIG. 1a shows an enlarged view of the apparatus according to the invention.

FIG. 1b shows an electric bicycle 80 with an apparatus according to the invention. The circular area A is shown enlarged in FIG. 1a. FIG. 1a shows a frame 70 with an apparatus 11. A release device 20 with a display 21 is arranged in the upper cross member.

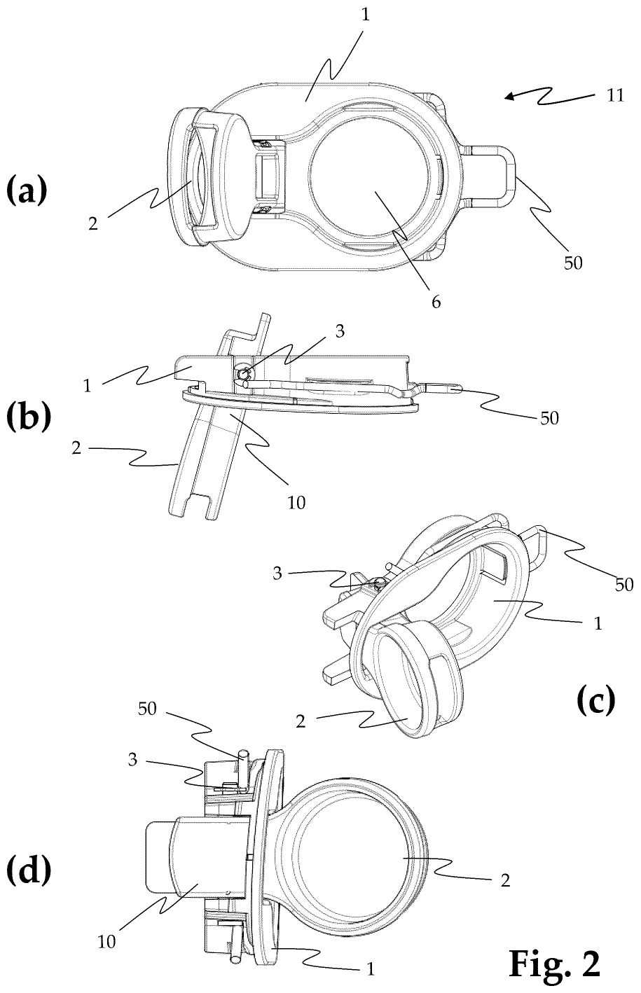

FIGS. 2a to d show a housing 1 of the apparatus 11 according to the invention in various three-dimensional representations.

FIG. 2a shows a front view of the housing 1 with an actuating element 2, which is in the open state. To mechanically unlock the battery, the actuating element 2 is moved or pressed to an opening angle of more than 90°. The housing 1 has a recess or cut-out 6, which serves as access 6 to a charging socket. FIG. 2a also shows part of a securing bracket 50.

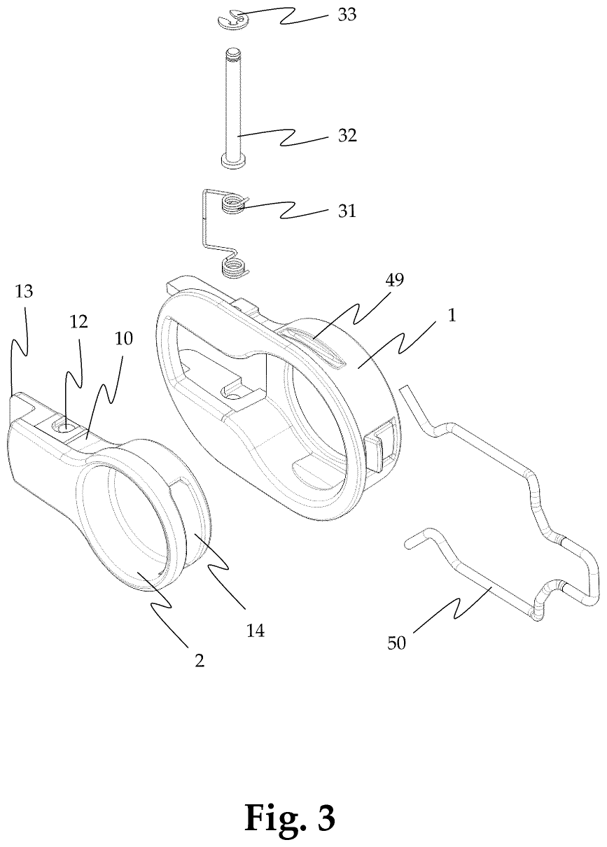

FIG. 2b shows a top view of the housing 1 with a built-in element 10, which comprises the actuating element 2. The built-in element 10 and the actuating element 2 can be designed together as one element. The built-in element 10 is attached to the housing 1 by means of a spring arrangement 3, which is described in more detail in FIG. 3. The securing bracket 50 can be seen from above. The built-in element 10 with actuating element 2 is in the open state, allowing access to the charging socket.

FIG. 2c shows a further three-dimensional view from the front. It shows the housing 1 with opened actuating element 2, the spring arrangement 3 and the securing bracket 50, which in turn is only partially visible.

FIG. 2d shows another three-dimensional view from the left. The built-in element 10 with actuating element 2 is folded open and is at an angle of 90° or more to the housing 1. The spring arrangement 3 and the securing bracket 50 are partially visible.

FIG. 3 shows the housing 1 with other components in a disassembled state. The housing 1 is oval in shape and has a groove 49 at the top and bottom. The built-in element 10 with actuating element 2 and an end 13 on the opposite side is clearly visible. The built-in element 10 has a shaft bushing 12. The actuating element 2 is designed as an engagement, which has a circular base and has a recess 14 in the front area. This recess 14 serves to simplify operation. The area can also be designed differently so that it can be easily gripped by the user as a kind of handle. The built-in element 10 with actuating element 2 fits precisely into the housing 1. The spring arrangement 3 is shown with a first spring 31, a shaft 32 and a locking ring 33. Two holes are provided in the housing 1. When installed, the built-in element 10 with actuating element 2 is located in the housing 1, with the shaft 32 running through the shaft bushing 12 and the holes. The first spring 31 is preloaded and the locking ring 33 is attached to the end of the shaft 32. This allows the built-in element 10 and the actuating element 2 to be moved or opened and closed under tension. The spring tension causes the built-in element 10 with actuating element 2 to fold back into the initial state after actuation. In the initial state, the built-in element 10 with actuating element 2 is advantageously located in the housing 1 and closes with it. The securing bracket 50 is shown on the side. As soon as the housing 1 is inserted into a precisely fitting recess in the frame 70, the securing bracket 50 can be inserted on the inside into the grooves 49 located at the top and bottom of the housing 1. This ensures that the housing 1 is securely fastened to the frame 70.

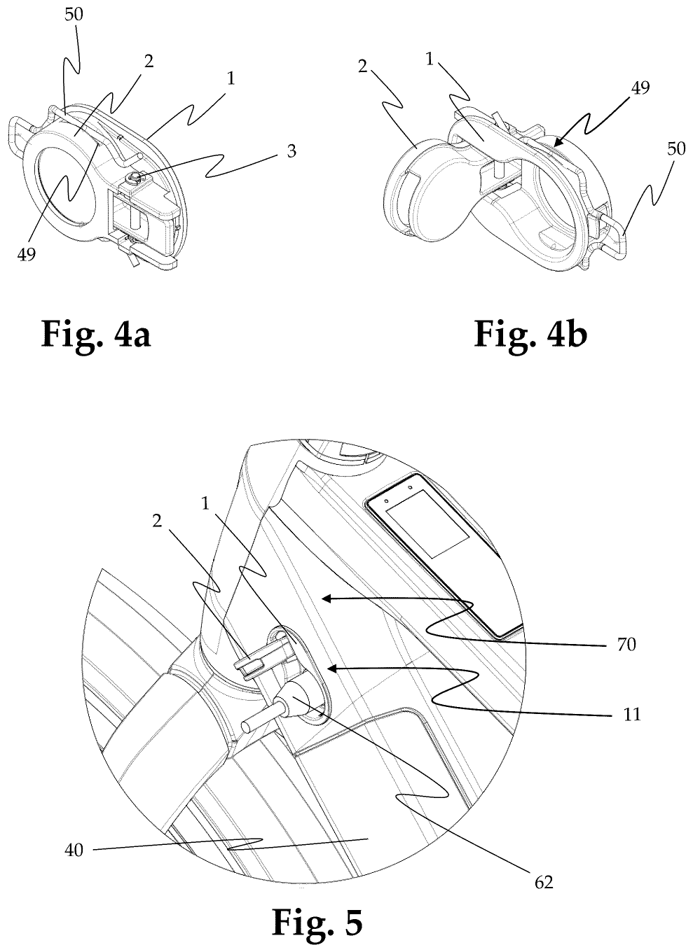

FIGS. 4a-b are schematic, three-dimensional representations of an apparatus according to the invention with the housing 1, which has the groove 49 for receiving the securing bracket 50, the actuating element 2 and the spring arrangement 3. In FIG. 4a, the apparatus 11 is shown from the rear, which forms the inside of the device after installation in a bicycle frame 70. The apparatus 11 in FIG. 4a is in a closed state. FIG. 4b, on the other hand, shows the device in an open but not unlocked state, with an opening angle=<90°, viewed from the front right. In this position, it is possible to connect a charging connection.

FIG. 5 shows a section of the electric bicycle 80 with the charging connection 62 connected. As the spring arrangement 3 exerts pressure on the actuating element 2, the actuating element 2 is pressed back to an angle of less than 90° after a charging connection 62 is connected, whereby the actuating element 2 can contact the charging connection 62. When the charging plug or the charging connection 62 is unplugged, the actuating element 2 snaps back into the initial state by itself due to the preload of the spring arrangement 3. As already mentioned, the charging connection and the battery unlocking are located on different sides of a bicycle frame in conventional electrically powered vehicles. FIG. 5 shows a preferred embodiment of the present invention, wherein the unlocking and locking apparatus and the charging connection are located in the same apparatus 11 and on the same side of a bicycle frame 70.

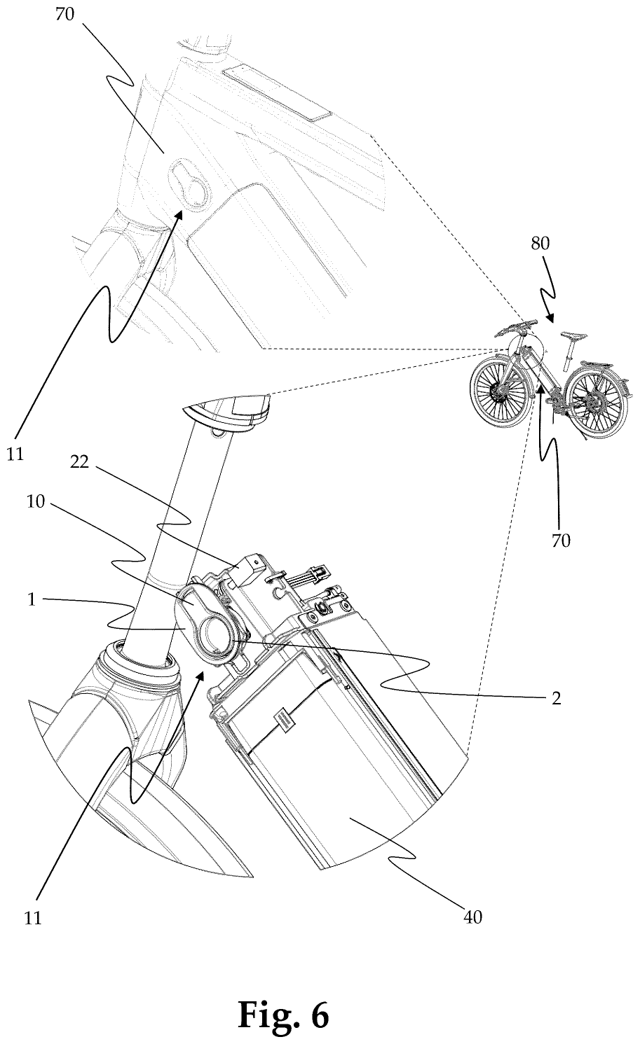

FIG. 6 shows a magnified view of the apparatus 11 according to the invention with electronic unlocking element 22 in the form of a solenoid coil. A partial view of the frame 70 with apparatus 11 as the opening mechanism is shown at the top. Below this, the interior of the bicycle frame 70 can be seen, where, in an advantageous embodiment of the present invention, the solenoid coil 22 is arranged close to the housing 1. When released by the release device 20, the solenoid coil 22 is caused to release a deflection lever 35 (not shown in FIG. 6), which moves a slider 42 (not shown in FIG. 6) through a second spring 41 (not shown in FIG. 6), which then releases the battery 40 so that the battery 40 is ejected.

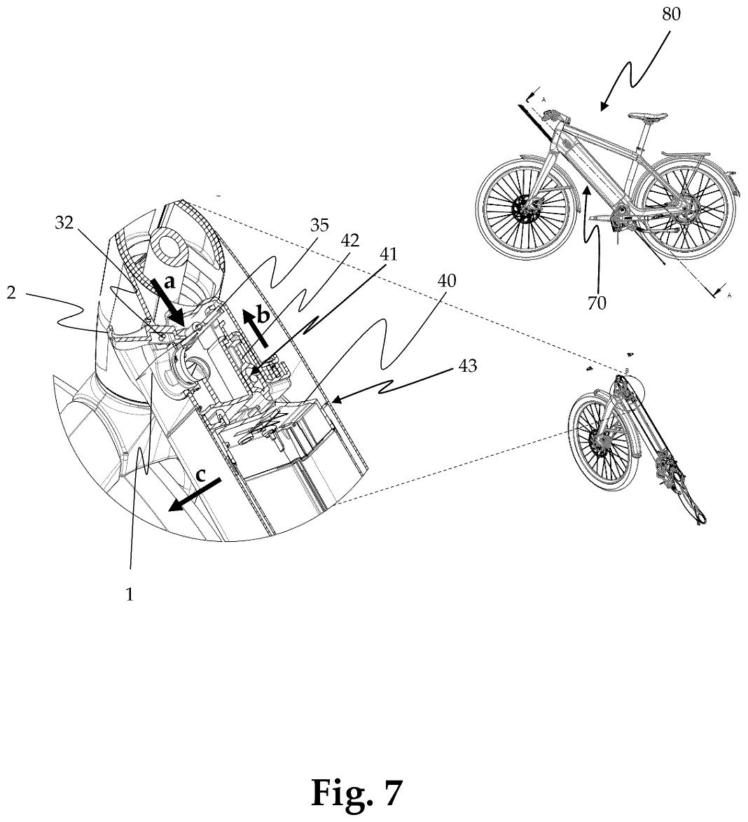

FIG. 7 shows an enlargement of the apparatus 11 according to the invention with force directional effects a, b, c in the unlocked state and with the charging socket 60 hidden along a section A-A corresponding to a circular area B. In a state to be unlocked, the built-in element 10 with actuating element 2 acts at one end or edge 13 on the deflection lever 35 (directional force effect a), which in turn pushes the slider 42 forwards in the direction of the bicycle frame 70 (directional force effect b), with the result that the second spring 41 releases the battery 40 and this is ejected due to a third spring 43 (directional force effect c). The second spring 41 pretensions the slider 42 so that the battery 40 is held securely in the frame. In an advantageous embodiment, the battery frame has a groove edge into which the slider 42 engages or latches when closed. In a further embodiment, the battery 40 has a curved surface section along which the slider 42 slides when the battery 40 is ejected or reinserted.

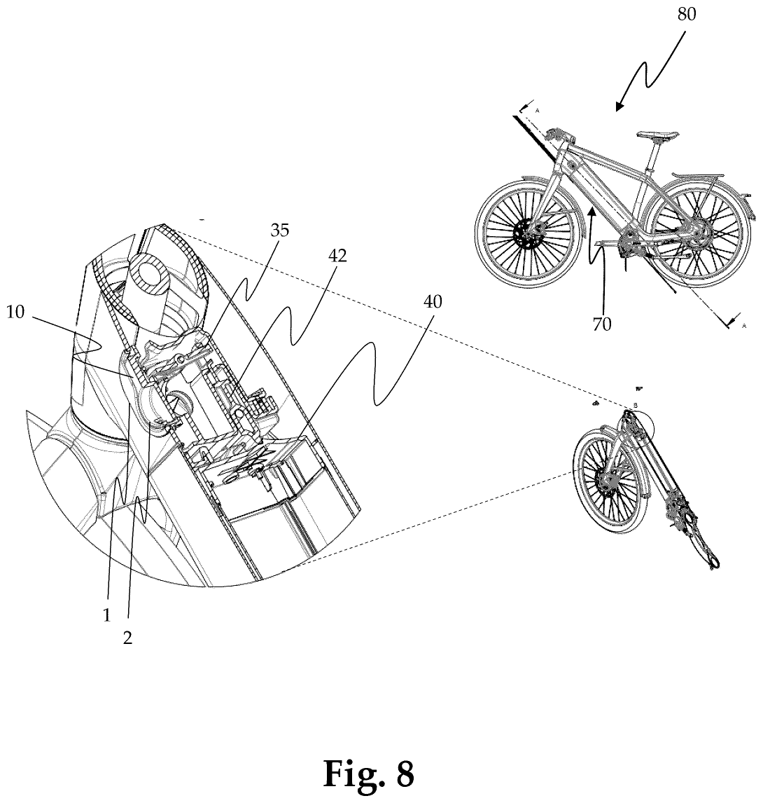

FIG. 8 shows an enlargement of the device 11 according to the invention in the closed or locked state and with the charging socket 60 hidden along a section A-A corresponding to a circular area B. In contrast to FIG. 7, the deflection lever 35 is in a straight, non-released position. The slider 42 is pretensioned by the second spring 41, which presses the slider 42 downwards along the direction of the bicycle frame 70. In the embodiment shown in FIG. 7, the slider 42 is engaged in the groove edge of the battery.

The present invention shows a locking and unlocking apparatus for an electrically driven vehicle. It goes without saying that numerous other embodiments in this field are conceivable for a person skilled in the art on the basis of the exemplary embodiments described.

### LIST OF REFERENCE SIGNS

1 housing
2 actuating element
3 spring arrangement
6 access to the charging socket
10 built-in element
11 apparatus
12 shaft feed-through
13 end of the built-in element for activating the deflection lever
14 recess
20 release device
21 display
22 electronic unlocking element, solenoid coil
31 first spring
32 shaft
33 locking ring
35 diverter lever
40 battery
41 second spring
42 slider
43 third spring
49 groove
50 securing bracket
60 charging socket
62 charging connection, charging plug
70 frame
80 electric bicycle

1. A locking and unlocking apparatus for an electrically driven vehicle, in particular an electric bicycle, comprising
a housing for accommodating components;
a built-in element for mechanical battery unlocking, wherein the built-in element comprises an actuating element for releasing the battery unlocking;
an electronic unlocking element; and
connected to a release device for releasing the mechanical battery unlocking by means of the electronic release element.

2. The apparatus according to claim 1, wherein the housing comprises an access to a charging socket.

3. The apparatus according to claim 1, wherein the built-in element is provided movably for opening and closing, respectively.

4. The apparatus according to claim 1, wherein the built-in element is attached to the housing by means of a spring arrangement with a first spring, a shaft and a locking ring.

5. The apparatus according to claim 1, wherein the mechanical battery unlocking comprises a second spring for ejecting a battery.

6. The apparatus according to claim 1, wherein the mechanical battery unlocking is effected by means of an actuating element and an opening angle of the actuating element of more than 90°.

7. The apparatus according to claim 1, wherein the housing is installable in a recess of a vehicle frame in a form-fitting manner and is protected by means of a securing bracket.

8. The apparatus according to claim 1, wherein the housing has at least one groove which accommodates a securing bracket for locking.

9. The apparatus according to claim 1, wherein the mechanical battery unlocking is carried out by the release device by means of the electronic unlocking element and the actuating element is moved to an opening angle of 90° or more.

10. The apparatus according to claim 1, wherein the mechanical battery locking takes place when the actuating element is at an opening angle of 90° or less.

11. The apparatus according to claim 1, wherein the electronic unlocking element comprises an electric solenoid.

12. The apparatus according to claim 1, wherein the release device is configured for mechanical battery unlocking by means of a code to be entered.

13. The apparatus according to claim 1, wherein a mechanical battery lock is provided by closing the actuating element after battery insertion.

14. A vehicle frame for an electrically driven vehicle, in particular an electric bicycle, for receiving and coupling with an apparatus according to claim 1.

15. A method of unlocking for an electrically driven vehicle, in particular an electric bicycle, by means of an apparatus according to claim 1, comprising the steps of:
release of the mechanical battery unlocking by the release device by means of an electronic release element; and
opening of the actuating element via an opening angle of more than 90°.

16. A method of locking for an electrically driven vehicle, in particular an electric bicycle, by means of an apparatus according to claim 1, comprising the step of:
closing the actuating element to a closing angle of 90° or less.
